(19) United States
(12) Patent Application Publication
(10) Pub. No.: US 2026/0080009 A1
(43) Pub. Date: Mar. 19, 2026

(54) SYSTEMS AND METHODS FOR MACHINE LEARNING-BASED CLASSIFICATION OF SIGNAL DATA SIGNATURES FEATURING USING A MULTI-MODAL ORACLE

(71) Applicant: Covid Cough, Inc., Greenwood Village, CO (US)

(72) Inventors: Mark Fogarty, Seneca, SC (US); Kristan S. Hopkins, North Andover, MA (US); Kitty Kolding, Parker, CO (US)

(73) Assignee: Covid Cough, Inc., Greenwood Village, CO (US)

(21) Appl. No.: 19/110,273

(22) PCT Filed: Sep. 15, 2023
(86) PCT No.: PCT/US2023/074315

§ 371 Date: Mar. 10, 2025

Related U.S. Application Data
(60) Provisional application No. 63/375,813, filed on Sep. 15, 2022.

(51) Int. Cl. G06F 16/65; G06N 20/20; G10L 15/16

(52) U.S. Cl. CPC G06F 16/65; G10L 15/16; G06N 20/20

(57) ABSTRACT

The disclosed systems and methods provide a novel technical solution via mechanisms for identifying which models are truly high-performing and the set of models that would provide the most accurate single prediction for a signal data signature (SDS). The disclosed systems and methods provides a computerized framework that can document the depictions of individual model performance. Moreover, the disclosed framework can identify all high performing models according to positive results, negative results, as well as generalized results. The framework can additionally operate to combine high performing models into a single predictive oracle to render a final prediction based on input from many models.

### CROSS-REFERENCE TO RELATED APPLICATIONS

This application claims priority to U.S. Provisional Application No. 63/375,813 filed on 15 Sep. 2022 and entitled “SYSTEMS AND METHODS FOR MACHINE LEARNING-BASED CLASSIFICATION OF SIGNAL DATA SIGNATURES FEATURING USING A MULTI-MODAL ORACLE,” and is herein incorporated by reference in its entirety.

### FIELD

The present disclosure relates generally to Artificial Intelligence (AI) and signature data signature classification. In particular, it relates to generalizable feature extraction from signal data signature segments in order to allow for classification of the signal data signatures. Feature extraction classifies and filters the quality of the signal data signature segment.

### BACKGROUND

Signal Data Signature (SDS) detection, segmentation, characterization, and classification is utilized for recognizing a source signal data signature and its accompanying parameters within a source signal data stream or recording (or other form of input).

### SUMMARY

The application of biometric and physiologic source signal data signature detection as a medical diagnostic or screening tool is particularly attractive as it represents a non-intrusive, real-time diagnostic that can be essential during public health crises. As discussed herein, the disclosed systems and methods provide a predictive ensemble/oracle for signal data signature (SDS) classification. In some embodiments, as discussed below, the disclosed technology specifically provides signal data signature classification utilizing neural networks and reinforcement learning.

Conventional mechanisms for event detection in signal data is limited by software programs that require human input and human decision points, algorithms that fail to capture the underlying distribution of a signal data signature, and algorithms that are brittle and unable to perform well on datasets that were not present during training. As an example, linear regression ensembles for machine learning utilize many neural network models that account for accuracy and sensitivity fluctuations between models for optimal performance, however, often the ensembles fail to provide consistent results for signal data signature feature identification and classification.

When a set of models is created for testing a set of SDSs, many neural network models will be generated (e.g., between 4,000 and 6,000, for example). From this large model set, it is desirable to ascertain a subset individual models (e.g., between 10 and 30, for example). Tools for evaluating model performance and determining a desired subset have been limited to and have focused on basic summary metrics like F1 score, PR AUC, Geometric Mean (Gmean), Spread, average Sensitivity and Specificity scores on a complete test set for each model. While these metrics are useful, they are consistently found ton only be a portion of the model performance behavior sought, and typically act as poor predictors of how a model will behave on various test sets.

Another shortcoming of such conventional approaches for obtaining the above-described metrics is that an arbitrary performance threshold is relied upon (e.g., 5). This frequently arises as not always being an appropriate threshold at which to evaluate model performance. On the other hand, discerning which threshold is ideal for each of the multitude of models has been a difficult challenge that has, until recently, been a task that conventional entities have been unable to accommodate with original test output data.

The disclosed systems and methods, therefore, provides a novel technical solution to such shortcomings, among others via the disclosed mechanisms for identifying which models are truly high-performing and the set of models that would provide the most accurate single prediction for an SDS. According to some embodiments, the disclosed systems and methods provides a computerized framework that can document the depictions of individual model performance. Moreover, the disclosed framework can identify all high performing models according to positive results, negative results, as well as generalized results. The framework can additionally operate to combine high performing models into a single predictive oracle to render a final prediction based on input from many models.

In accordance with some embodiments, the present disclosure provides computerized methods for a predictive ensemble/oracle for SDS classification. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a predictive ensemble/oracle for SDS classification.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates a signal data signature detection system in accordance with some embodiments of the present disclosure;

FIG. 2 illustrates a non-limiting example SDS processing according to some embodiments of the present disclosure;

FIG. 3 depicts a non-limiting example workflow of the disclosed systems and methods according to some embodiments of the present disclosure;

FIG. 4 depicts a block diagram of an exemplary computer-based system and platform 700 in accordance with some embodiments of the present disclosure;

FIG. 5 depicts a block diagram of another exemplary computer-based system and platform 800 in accordance with some embodiments of the present disclosure;

FIG. 6 illustrates schematics of an exemplary implementation of the cloud computing/architecture(s) in accordance with some embodiments of the present disclosure; and

FIG. 7 illustrates schematics of another exemplary implementation of the cloud computing/architecture(s) in accordance with some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing (or client) device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant, a handheld computer, a tablet computer, a phablet, a laptop computer, a set top box, a wearable computer, smart watch, an integrated or distributed device combining various features, such as features of the forgoing devices, or the like.

Certain embodiments and principles of the instant disclosure will now be described in greater detail.

According to some embodiments of the present disclosure, the disclosed framework operates for SDS detection, including when/where a function approximator machine learning comprises deep learning neural networks.

Embodiments of the present disclosure include systems, methods and/or non-transitory computer readable storage media for signal data signature to individually (or according to a set or grouping) test neural network models in a selected group of models based on multiple parameter thresholds, and provides calculation methods to determine the best performance conditions for each model based on a given test set.

### Model Performance Confusion Matrix

According to some embodiments of the present disclosure, the disclosed framework can first necessitate the creation of a dataset, which holds predictions generated by a testing pipeline for a given set of SDSs evaluated by neural network modes. The table contains the results of predicting all the audio samples in a given dataset against all the models in a model set. Each row in the dataset represents a single cough from a recording holds a variety data related to the SDS and SDS segments (i.e., individual coughs).

In some embodiments, each model is tested against every SDS segment in the SDS dataset, generating a confusion matrix for each model using the four different aggregation methods (1) average (avg), (2) maximum (max), (3) vote (vote), and (4) vote average (votea) at 35 different threshold values starting at 0.05 up to 0.9 in 0.025 steps.

In some embodiments, values for aggregation methods are generated via methods referred to as posmeth and negmeth. The method scores a model for given SDS segment (i.e., single cough or split) for positive predictions. posmeth is used to build the confusion matrix for a given model and to predict positives with the oracle (for positive oriented models). Similarly, negmeth does this for negatives.

According to some embodiments, a number (e.g., 4) of different aggregation methods can be utilized, where each utilizes a corresponding value(s).

In some embodiments, a first aggregation method corresponds to an average (avg) functionality. In some embodiments, such avg method involves, if posmeth corresponds to an average, then the model predicts a positive if the average of the predictions of all the splits in a sample is greater than the posthresh value. If negmeth corresponds to an average, then the model predicts a negative if the average of the predictions of all the splits in a sample is less than the negthresh value.

In some embodiments, a second aggregation method corresponds to a max. In some embodiments, if posmeth is a maximum, then the model predicts positive if the maximum value of the predictions of all the splits in a sample is greater than the posthresh value. If negmeth is a maximum, then the model predicts negative if the maximum value of the predictions of all the splits in a sample is less than the negthresh value.

In some embodiments, a third aggregation method corresponds to a vote. In some embodiments, if posmeth corresponds to a vote, then the model predicts positive if more than half of the predictions on the splits in a sample are greater than the posthresh value. If negmeth corresponds to a vote, then the model predicts negative if more than half of the predictions on the splits in a sample are less than the negthresh value. And, if there is an even number of splits in a sample then the vote can be a tie, in which case it does not make a prediction.

In some embodiments, a fourth aggregation method corresponds to votea, which can be similar to the vote methodology; however, in the case of a tie, the average of the predictions is compared to the threshold as a tiebreaker. In some embodiments, if posmeth is votea, then the model predicts positive if more than half of the predictions on the splits in a sample are above the posthresh value, or if half are above and half are below (a tie), and the average of all the predictions is above the posthresh value. If negmeth is votea, the model predicts negative if more than half of the predictions are below the negthresh value, or if half of the predictions are above negthresh and half are below, and the average of all predictions is below negthresh.

Accordingly, in some embodiments, each SDS segment can then be correlated to a set of a predetermined number of results (e.g., 140) for each model which are stored, which can then be evaluated for optimal grouping with other models.

### Model Performance Evaluation

According to some embodiments of the present disclosure, use of the disclosed systems and methods can involve identifying neural network models that, when they make a prediction, have no false positives and/or no false negatives, collectively known as “no falses”) or get a low percentage wrong (ex. under 10% incorrect on either positive or negative).

According to some embodiments, use of a confusion matrix (e.g., allresults table) for a given model can be effectuated to select the optimum “nofalse” configuration(s) for each model based on the threshold values tested. The nofalse configuration is the positive threshold and method that provides the greatest number of true positives with zero false positives from that model on the test set, as well as the negative threshold and method that provides the greatest number of true negatives with no false negatives.

### Model Performance Grouping

In some embodiments and, optionally, in combination of any embodiment described herein, a method iterates through the list of nofalse configuration models in decreasing order of number of predictions made. Each time, a new nofalse model is identified, it is fed to the test function. If the model increases the number of true positives or true negatives predictions the model is kept in the performance group, if it does not add any more true positives or true negatives, it is excluded.

In some embodiments and, optionally, in combination of any embodiment described above or below, to ensure evaluation of models (from thousands of models, for example), smaller models can be grouped to test group combinations by model classification such as, but not limited to, Image type (FFT, MEL, MFCC) and or Sample Rate (8k, 16, 24, 48k) from a given classification. Accordingly, in some embodiments, the resulting model grouping may be designated as the “nofalse stack”.

In some embodiments and, optionally, in combination of any embodiment described above or below, with the optimal values for both positives and negatives identified for all the models, models are then grouped together starting with the model and configuration which gets the truest positives and then the model and config that gets the most true negatives. The configuration information for those two models, in sequence, are loaded into the oracle definition and passed to the oracle test function to establish a baseline of how many true positives or true negatives predictions just those two models can make. Subsequently, each other nofalse record is tried as the next model in the stack. This method identifies which models work together to achieve the best results when combined by matching them and finding the ideal partner model.

In some embodiments, in order to group the positive predictors and the negative predictors, data which predicted less than 10% of the positives and negative incorrectly and respectively can be grouped. In some embodiments, permutations of the positive predictors list, taken 2 at a time, can be fed to the test function, and results are tabulated. This result in a list of pairs of models and configurations, and the number of true and false positives each pair predicts. Once this list of positive pairs and their performance are determined (or otherwise identified), the disclosed framework can select the best pairs as finalists, where those positive pairs are provided as the first models in a stack with each of the remaining positive predictors to find the best set of models for predicting positives. In some embodiments, a threshold is selected for the maximum number of false positives the model sets are allowed to predict. These models are saved as the “positive predictor stack”.

In some embodiments, this process is repeated for negative predictors, attempting all pairs of models which got less than 10% of the negatives wrong to select the best pairs, then attempting those pairs with each of the remaining negative predictors to identify the 3-model stack that predicts negatives best without getting too many wrong (e.g., at or below a threshold value). These models are grouped as the “negative predictor stack”.

Accordingly, the grouped stacks, supra, can be assembled into a nearly complete oracle. In some embodiments, the nofalse stack is on top, below that go the positive predictors, then the negative predictors. In some embodiments, the oracle can be permitted to be inconclusive (‘I don't know’), whereby according to such embodiments, the definition of oracle can be considered complete.

In some embodiments and, optionally, in combination of any embodiment described above or below, if a prediction for all the SDSs are required, the final step is to attempt all model configurations as the last model in the stack, or the “base model”. In the base model, all model configurations that resulted in at least 50% of the positives correct and 50% of the negatives correct when tested on the whole set are grouped together. Each one is added as the last model, configured to predict both positives and negatives, and overall performance is tested. Results from the stack with each potential base model in place are saved to a csv. After reviewing the csv for sensitivity, specificity, accuracy and f1, a final base model is selected and the oracle definition is complete.

### Oracle Definition

In some embodiments and, optionally, in combination of any embodiment described above or below, once the no false stack is identified, a definition of the model grouping is created in a file, database, array, memory, and the like, or some combination thereof. This is called the oracle definition, provide a listing of model, the structure of the model grouping, order they should be used as well as model parameters and thresholds, and aggregation methods that should be used for each model to predict positives and/or negatives.

### Oracle Prediction and Results

According to some embodiments, in order to predict an SDS, the system starts by obtaining the predictions from the first model pairing for all the SDS segments (a single cough), then aggregating those predictions using the method specified by posmeth at the threshold specified by posthresh for that model. If that results in a positive prediction, then that SDS is predicted as positive and the system returns a positive result and processing is done.

If the sample is not predicted as positive, the system evaluates negmeth at negthresh in the model grouping. If negative then the sample is predicted as negative, a negative result is output/returned, and processing is done. If this model does not predict the sample as either positive or negative, then that constitutes an inconclusive result (‘I don't know’), and the system processes to the next model. This is repeated until a prediction is reached or the model list is exhausted with inconclusive results.

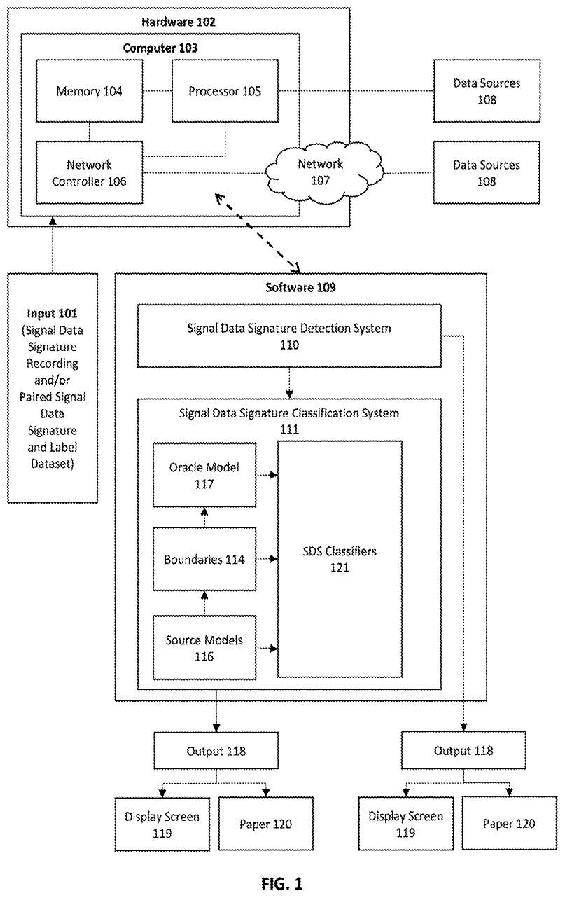

Turning to FIG. 1, FIG. 1. illustrates a signal data signature detection system according to some embodiments of the present disclosure. FIG. 1 depicts a broad schematic for the entire process of SDS audio sample to a final prediction. Currently it shows the combination of audio collection, cough detection, audio segmentation, neural network models, and formant Feature extraction to achieve a final prediction in accordance with aspects of embodiments of the present disclosure (Oracle Model 117), as discussed below.

FIG. 1. illustrates a signal data signature detection system 110 with the following components: input 101, hardware 102, software 109, and output 118. The input 101 is a signal data signature recording such as a signal data signature recording captured by a sensor, a signal data signature recording captured on a mobile device, and a signal data signature recording captured on any other device, among others. The input 101 may be provided by an individual, individuals or a system and recorded by a hardware device 102 such as a computer 103 with a memory 104, processor 105 and or network controller 106. A hardware device is able to access data sources 108 via internal storage or through the network controller 106, which connects to a network 107.

In some embodiments, a user may record an input 101 including an audio recording of a vocalization, such as a cough vocalization, including forced and/or unforced cough vocalizations. In some embodiments, the input 101 may be recorded using a recording device. For example, the recording device may include one or more microphones and a software application configured to use the microphones for recording sounds. However, in some embodiments, the recording device may be a peripheral or connected device connected to a user computing device, and the user computing device may include a software application configured to receive or obtain a recording from the recording device.

In some embodiments, the sound signal data signature may include a forced non-speech vocalization, such as, e.g., a cough. A sound signature of forced non-speech vocalizations is unique to each individual. Thus, the user computing device may instruct the user to force a cough vocalization as a way to authenticate a user's identity. The sound signal data signature may also be used to assess changes to the sound signature of the user's sound signal data signature by, e.g., comparing the sound signal data signature to a baseline signature. Thus, the sound signal data signature may be employed to assess any potential changes to the user's sound signal data signature that may indicate a potential respiratory anomaly such as, e.g., any agent, substance, vapor or condition that has an effect on the respiratory system such as, e.g., infections including influence, coronavirus (e.g., the common cold, COVID-19, and the like), pneumonia, bronchitis, or other diseases, conditions such as chronic obstructive pulmonary disease (COPD), asthma, allergies, emphysema, or other conditions, environmental factors such as humidity, air quality and pollution, foreign bodies, foreign substances, and the like, or any other respiratory effecting factor or any combination thereof.

In some embodiments, a sound signal data signature detection system 110 may be in communication with the recording device, e.g., via a network or direct connection. In some embodiments, hardware 102 and/or software 109 of the signal data signature detection system 110 may be configured to receive the input 101 and utilize a signal data signature classifier system 111 in order to identify sound signal data signatures that may represent a condition associated with the input 101.

Accordingly, in some embodiments, the recording device may provide the sound signal data signature to the sound signal data signature detection system 110, e.g., via a sound signal data signature analysis interface. In some embodiments, the sound signal data signature analysis interface may include any suitable interface for data communication over, e.g., a network 107, or via local or direct data communication infrastructure. For example, in some embodiments, the sound signal data signature analysis interface may include wired interfaces such as, e.g., a Universal Serial Bus (USB) interface, peripheral component interconnect express (PCIe), serial AT attachment (SATA), or any other wired interface, or wireless interfaces such as, e.g., Bluetooth™, Bluetooth Low Energy (BLE), NFC, RFID, Narrow Band Internet of Things (NBIOT), 3G, 4G, 5G, GSM, GPRS, WiFi, WiMax, CDMA, satellite, ZigBee, or other wireless interface, or any combination of any wired and/or wireless interfaces. In some embodiments, the recording device may communicate the sound signal data signature via the sound signal data signature analysis interface 114 using any suitable data communication protocol, such as, e.g., IPX/SPX, X.25, AX.25, AppleTalk™, TCP/IP (e.g., HTTP), application programming interface (API), messaging protocol or any combination thereof.

In some embodiments, the sound signal data signature analysis interface may include, e.g., an application programming interface. In some embodiments, “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

In some embodiments, the sound signal data signature detection system 110 may receive the sound signal data signature of the input 101 and analyze the sound signal data signature to determine a sound signal data signature recording of the sound signal data signature isolated from noise and artifacts of in the recorded sound signal data signature, generate a signature for the sound signal data signature recording, and generate a label for the input classifying the sound signal data signature recording, e.g., via a signal data signature classifier system 111. In some embodiments, the sound signal data signature classifier system 111 may include hardware and software components including, e.g., the computer 103 (e.g., including a processor 105, a memory 104, a network controller 106, and the like), e.g., embodied in a user computing device, server, cloud, or a combination thereof.

In some embodiments, the processor 105 may include local or remote processing components. In some embodiments, the processor 105 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 105 may include data-processing capacity provided by the microprocessor. In some embodiments, the microprocessor may include memory, processing, interface resources, controllers, and counters. In some embodiments, the microprocessor may also include one or more programs stored in memory.

In some embodiments, the memory 104 may include any suitable data storage solution, such as local hard-drive, solid-state drive, flash drive, database or other local storage, or remote storage such as a server, mainframe, database or cloud provided storage solution. In some embodiments, the data storage solution may include, e.g., a suitable memory or storage solutions for maintaining electronic data representing the activity histories for each account. For example, the data storage solution may include database technology such as, e.g., a centralized or distributed database, cloud storage platform, decentralized system, server or server system, among other storage systems. In some embodiments, the data storage solution may, additionally or alternatively, include one or more data storage devices such as, e.g., a hard drive, solid-state drive, flash drive, or other suitable storage device. In some embodiments, the data storage solution may, additionally or alternatively, include one or more temporary storage devices such as, e.g., a random-access memory, cache, buffer, or other suitable memory device, or any other data storage solution and combinations thereof.

In some embodiments, the signal data signature detection system 110 may implement computer engines, to determine a sound signal data signature recording of the input 101 isolated from noise and artifacts, a signal data signature classifier system 111 to leverage machine learning models in a transfer learning system 112 to generate one or more labels classifying the input 101 according to trained ML model(s) 113, boundaries 114, a source model 116 and a SDS classifier(s) 121. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, the data sources 108 that are retrieved by the hardware device 102 in one of other possible embodiments includes for example but not limited to: 1) imbalanced paired training dataset of signal data signature recordings and labels and unlabeled signal data signature recording, 2) balanced paired training dataset of signal data signature recordings and labels and unlabeled signal data signature recording, 3) imbalanced paired training dataset of video recordings and labels and unlabeled video recording, 4) imbalanced paired training dataset of video recordings and labels and unlabeled signal data signature recording, 5) paired training dataset of signal data signature recordings and labels and unlabeled video recording. In some embodiments, the term “imbalance” refers to an unequal number of labeled training data compared to labeled training data. Similarity, the term “balance” refers to an equal number of labeled training data compared to labeled training data.

In some embodiments, the data sources 108 and the signal data signature recording input 101 are stored in memory or a memory unit 104 and passed to a software 109 such as computer program or computer programs that executes the instruction set on a processor 105. The software 109 being a computer program executes a signal data signature detector system 110 and a signal data signature classification system 111. The signal data signature classification system 111 executes a signal data signature classifier system 111. The source models 116 define the boundaries 114 and scope to best classify the target. The source models 116 are trained on subsets of the entire training set in order to attempt to deal with data variance among datasets. These source models 116 are also trained using slightly varying model architectures in an attempt to provide a little more understanding of the classification boundaries 114. The oracle model 117 is trained on a new unique dataset that is predicted upon by all the source models 116. The predictions from the source models 116 are used as the oracle model 117 inputs which are then weighted to produce one final result that classifies that outcome of the system. This outcome is a probability (between 0 and 1) that the provided observation belongs to class A which can also be considered as the 1−p probability that it belongs to class B. The system uses the combination of the source models 116 and the final oracle model 117 to produce the predictive value for the user. In some embodiments, the output 118 is a label that indicates the presence or absences of a condition given that an unlabeled signal data signature recording is provided as input 101 to the signal data signature detection system such that the output 118 can be viewed by a reader on a display screen 119 or printed on paper 120.

In some embodiments, a suitable optimization function may be used to train the classifier models, including the source models 116 and the oracle model 117. In some embodiments, each source model 116 and the oracle model 117 may be separately trained using an associated optimization function. For example, each source model 116 may be used to predict a probability value for a training signal data signature and then trained based on error from the associated labeled training data using each associated optimization function. The oracle model 117 may be trained using the predicted probability value from each source model 116 as input to predict a final predicted probability value, and then trained based on the error from the associated labeled training data using the associated optimization function. In some embodiments, the optimization function may employ a loss function, such as, e.g., Hinge Loss, Multi-class SVM Loss, Cross Entropy Loss, Negative Log Likelihood, or other suitable classification loss function to determine the error of the predicted label based on the known output. In some embodiments, the optimization function may include any suitable minimization algorithm for backpropagation such as a gradient method of the loss function with respect to the weights of the classifier machine learning model. Examples of suitable gradient methods include, e.g., stochastic gradient descent, batch gradient descent, mini-batch gradient descent, or other suitable gradient descent technique.

In some embodiments, the signal data signature detection system 110 hardware 102 includes the computer 103 connected to the network 107. The computer 103 is configured with one or more processors 105, a memory or memory unit 104, and one or more network controllers 106. In some embodiments, the components of the computer 103 are configured and connected in such a way as to be operational so that an operating system and application programs may reside in a memory or memory unit 104 and may be executed by the processor or processors 105 and data may be transmitted or received via the network controller 106 according to instructions executed by the processor or processor(s) 105. In some embodiments, a data source 108 may be connected directly to the computer 103 and accessible to the processor 105, for example in the case of a signal data signature sensor, imaging sensor, or the like. In some embodiments, a data source 108 may be executed by the processor or processor(s) 105 and data may be transmitted or received via the network controller 106 according to instructions executed by the processor or processors 105. In one embodiment, a data source 108 may be connected to the signal data signature classifier system 111 remotely via the network 107, for example in the case of media data obtained from the Internet. The configuration of the computer 103 may be that the one or more processors 105, memory 104, or network controllers 106 may physically reside on multiple physical components within the computer 103 or may be integrated into fewer physical components within the computer 103, without departing from the scope of the present disclosure. In one embodiment, a plurality of computers 103 may be configured to execute some or all of the steps listed herein, such that the cumulative steps executed by the plurality of computers are in accordance with the present disclosure.

In some embodiments, a physical interface is provided for embodiments described in this specification and includes computer hardware and display hardware (e.g., the display screen of a mobile device). In some embodiments, the components described herein may include computer hardware and/or executable software which is stored on a computer-readable medium for execution on appropriate computing hardware. The terms “computer-readable medium” or “machine readable medium” should be taken to include a single medium or multiple media that store one or more sets of instructions. The terms “computer-readable medium” or “machine readable medium” shall also be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. In other embodiments, some of these operations might be performed by specific hardware components that contain hardwired logic. Those operations might alternatively be performed by any combination of programmable computer components and fixed hardware circuit components.

In one or more embodiments of the signal data signature classifier system 111 software 109 includes the signal data signature classifier system 111 which will be described in detail below.

In one or more embodiments of the signal data signature detection system 110 the output 118 includes a strongly labeled signal data signature recording and identification of signal data signature type. An example would be signal data signature sample from a patient which would include: 1) a label of the identified signal data signature type, 2) or flag that tells the user that a signal data signature was not detected. The output 118 of signal data signature type or message that a signal data signature was not detected will be delivered to an end user via a display medium such as but not limited to a display screen 119 (e.g., tablet, mobile phone, computer screen) and/or paper 120.

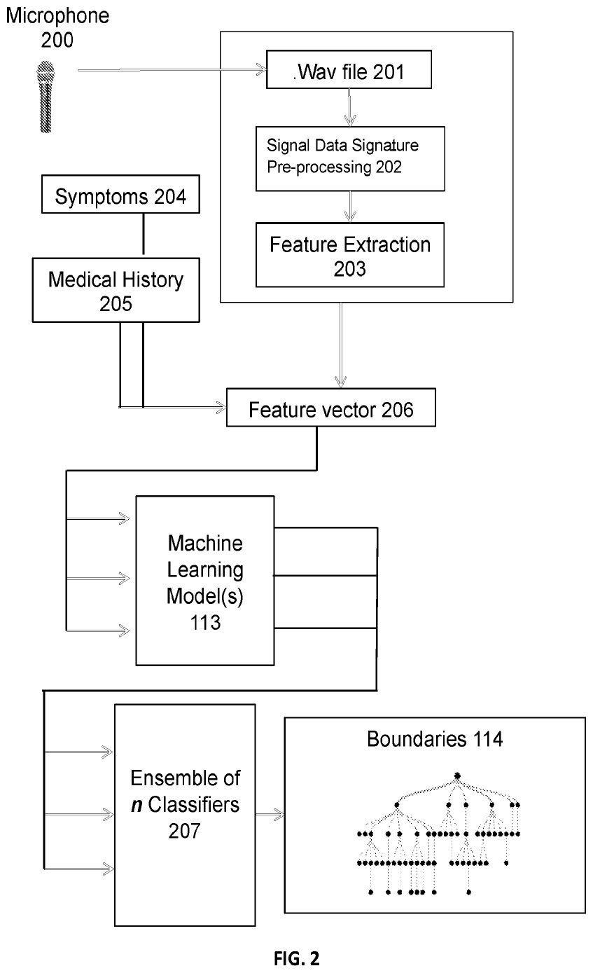

In some embodiments, a signal data signature classifier system 111 with real-time training of machine learning models 113 and the real-time training of model(s) 113 and the source model 116, hardware 102, software 109, and output 118. FIG. 2. illustrates an input to the signal data signature classifier system 111 that may include but is not limited to paired training dataset of signal data signature recordings and corresponding signal data signature labels and an unpaired signal data signature recording 101 that is first received and processed as a signal data signature wave by a hardware device such as a microphone 200. In addition, the signal data signature labels may be input into the signal data signature classifier system using a physical hardware device such as a keyboard.

In some embodiments, the signal data signature classifier system 111 uses a hardware 102, which includes a memory or memory unit 104, and processor 105 such that software 109, a computer program or computer programs is executed on a processor 105 and trains in real-time a set of signal data signature classifiers. The output from signal data signature classifier system 111 is a label 118 that matches and diagnosis a signal data signature recording file. A user is able to the signal data signature type output 118 on a display screen 119 or printed paper 120.

In some embodiments, the signal data signature classifiers may be configured to utilize one or more exemplary AI/machine learning techniques for data classification tasks, e.g., such as one or more of the techniques including, but not limited to, decision trees, boosting, support-vector machines, neural networks, nearest neighbor algorithms, Naive Bayes, bagging, random forests, and the like. In some embodiments and, optionally, in combination of any embodiment described above or below, the signal data signature classifiers may include an exemplary neutral network technique such as, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
a. define Neural Network architecture/model,
b. transfer the input data to the exemplary neural network model,
c. train the exemplary model incrementally,
d. determine the accuracy for a specific number of timesteps,
e. apply the exemplary trained model to process the newly-received input data,
f. optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

FIG. 2 depicts a partial view of the signal data signature detection system 110 as elements of 202, with an input signal data signature recording 101 captured using a physical hardware device, microphone 200; such that the signal data signature signal is captured as a .wav file 201, or any other type of computer readable signal data signature signal formatted file, and is then pre-processed 202. Signal Data Signature Pre-Processing 202 imposes a few, basic standards upon the sample via one or more cleansing, filtering and/or normalizing processes. Such cleansing, filtering and/or normalizing ensures high-quality audio files. These filters act to address concerns regarding audio quality for processing, such as, e.g., stereo to mono compatibility, peak input loudness level, and attenuation of unrelated low frequencies or other ancillary noise. Additionally, any other suitable filters may be employed for signal quality optimization, such as one or more filters for, e.g., dynamic range modification (e.g., via dynamic range compression or expansion), optimization of signal to noise ratio, removal, suppression or otherwise mitigation of ancillary noise(s), implementation of bandlimiting to isolate frequency content within a range of interest (e.g., via resampling or the use of equalization filters), among other signal optimizations or any combination thereof. For example, background noise may be filtered from a sample including one or more recordings of a vocalization, and then the vocalization with the recording(s) can be identified, e.g., using a Pretrained Audio Neural Network (PANN) or other detection/recognition tools or any combination thereof. Thus, audio samples that do not contain a vocalization may be prevented from being processed by the system to avoid unnecessary resource utilization.

In some embodiments, the SDSs above the threshold for match are then passed to a classifier 121, such as a deep learning or other supervised learning classifier model such as, e.g., a neural network-based classifier (e.g., a convolutional neural network (CNN), recurrent neural network (RNN), or other deep learning neural network (DNN) or any combination thereof), of the signal data signature classifier system 111. This enables the determination of, for example, qualities related to a COVID-19 diagnosis.

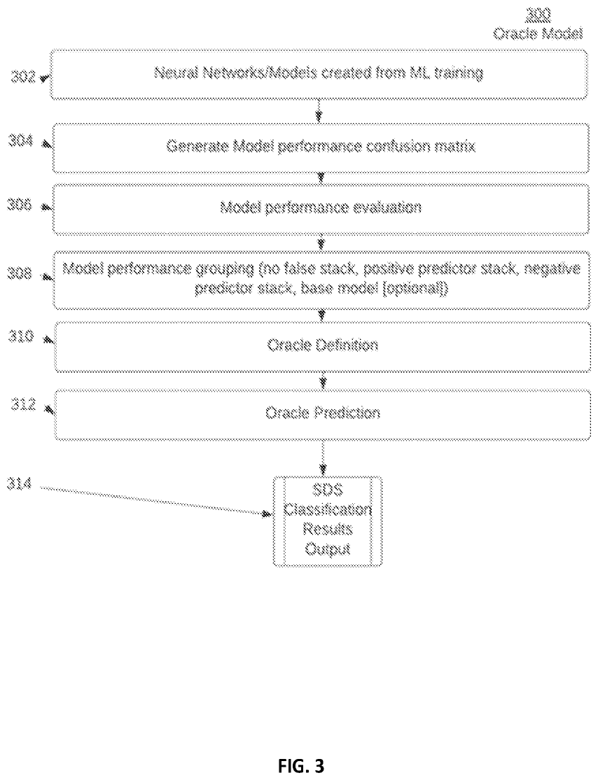

Turning now to FIG. 3, Process 300 (referred to as the “oracle model”) is disclosed which provides functionality for a learned classification of the signal data signatures.

Process 300 begins with Step 302 where a set of neural networks/models are created from the performance of machine learning (ML) training. According to some embodiments, such training can be performed in a similar manner as discussed above, at least in reference to FIG. 1, supra.

In Step 304, a model performance confusion matrix is generated. Non-limiting example embodiments of the functionality of Step 304 are discussed above, at least in reference to the section related to the “model performance confusion matrix,” supra.

In Step 306, a model performance evaluation is performed. Non-limiting example embodiments of the functionality of Step 306 are discussed above, at least in reference to the section related to the “model performance,” supra.

In Step 308, model performance groupings are performed. Non-limiting example embodiments of the functionality of Step 308 are discussed above, at least in reference to the section related to the “model performance grouping,” supra.

In Step 310, an oracle definition is determined and stored. Non-limiting example embodiments of the functionality of Step 310 are discussed above, at least in reference to the section related to the “oracle definition,” supra.

In Step 312, an oracle prediction is performed. Non-limiting example embodiments of the functionality of Step 312 are discussed above, at least in reference to the section related to the “oracle prediction and results,” supra. In some embodiments, the oracle prediction can be performed based on an input audio file, as discussed above at least in reference to FIGS. 1-2, supra.

And, in Step 314, an SDS classification result(s) is output. Non-limiting example embodiments of the functionality of Step 314 are discussed above, at least in reference to the section related to the “oracle prediction and results,” supra.

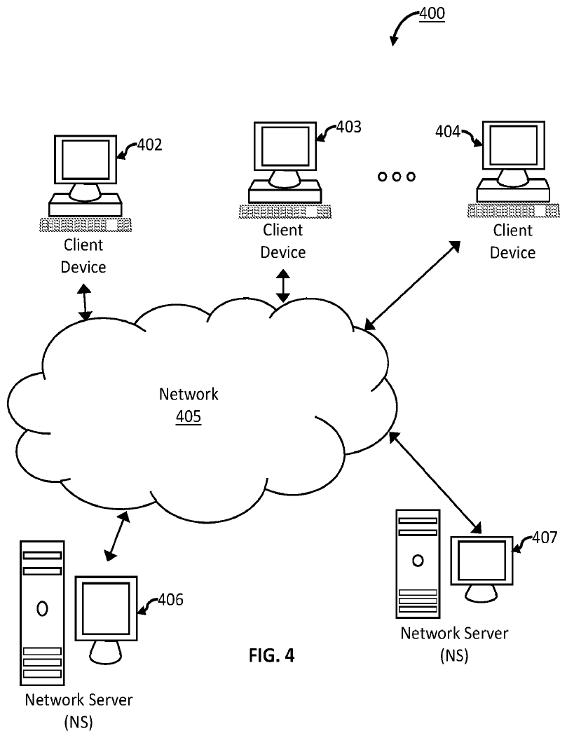

Turning to FIG. 4, depicted is a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, members 402-404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, and the like). In some embodiments, one or more member devices within member devices 402-404 may include may run one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments, in combination of any embodiment described above or below, the exemplary network 405 may also include, for instance, at least one of a LAN, a WAN, the Internet, a virtual LAN (VLAN), an enterprise LAN, a layer 3 virtual private network (VPN), an enterprise IP network, or any combination thereof. In some embodiments, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as NAS, SAN, CDN or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, and the like. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

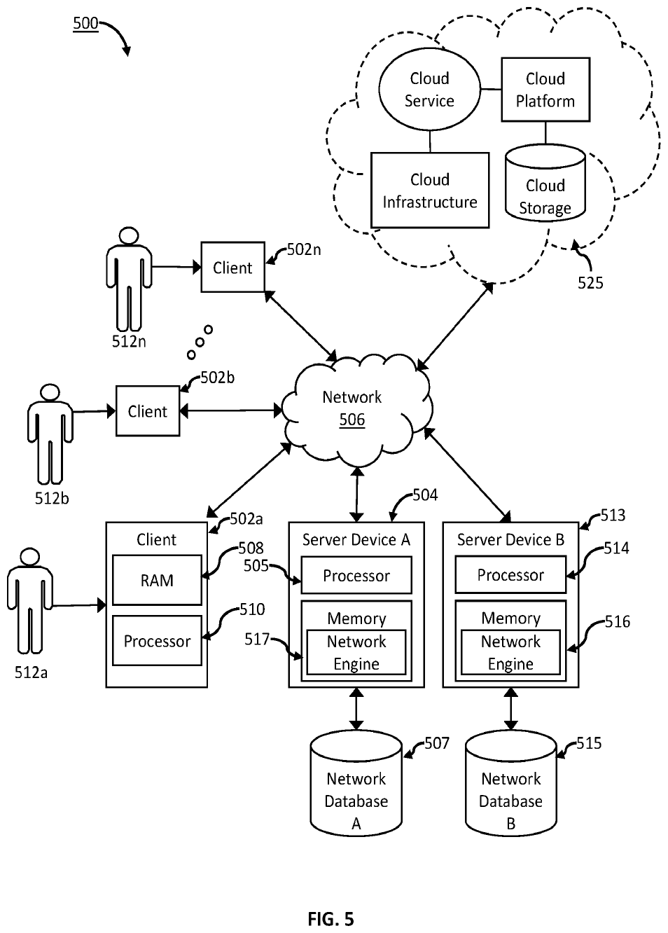

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and the like.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 502n, may communicate over the exemplary network 506 with each other and/or with other systems and/or devices coupled to the network 506. As shown in FIG. 5, exemplary server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

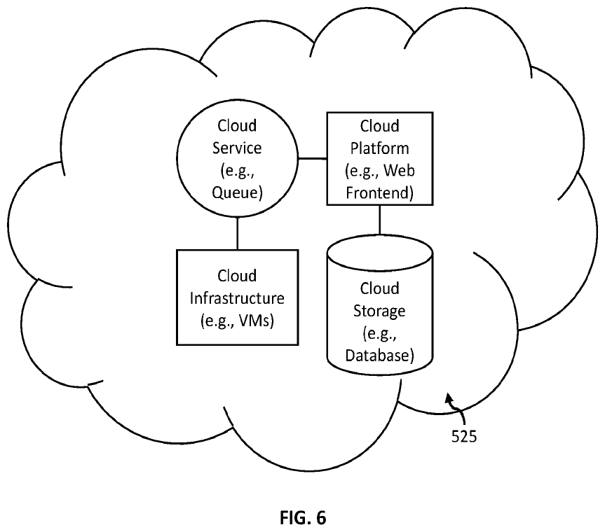

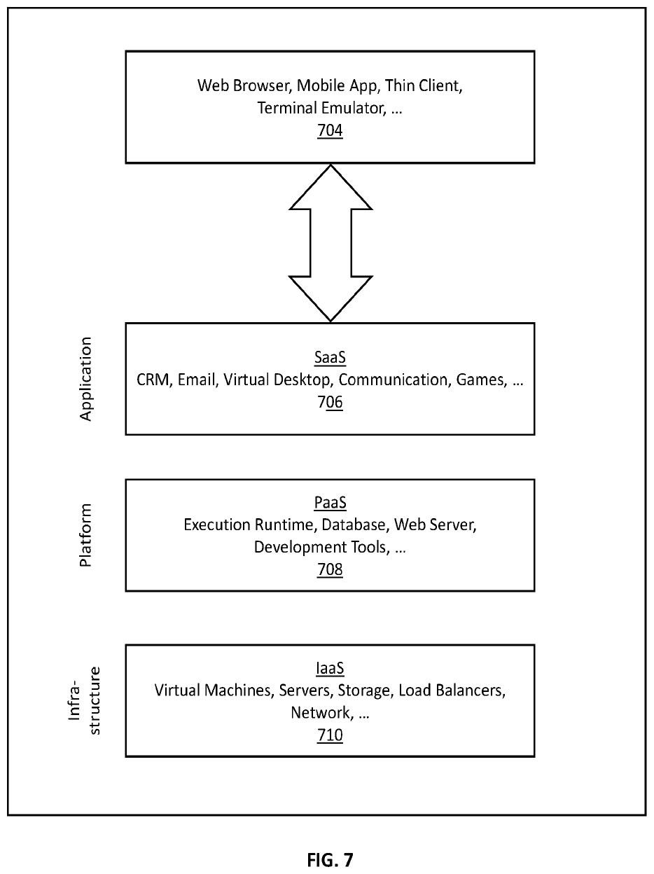

FIG. 6 and FIG. 7 illustrate schematics of exemplary implementations of the cloud computing/architecture(s) in which the exemplary novel computer-based systems/platforms, the exemplary novel computer-based devices, and/or the exemplary novel computer-based components of the present disclosure may be specifically configured to operate. In some embodiments, the exemplary novel computer-based systems/platforms, the exemplary novel computer-based devices, and/or the exemplary novel computer-based components of the present disclosure may be specifically configured to operate in a cloud computing/architecture 525 such as, but not limiting to: infrastructure a service (IaaS) 710, platform as a service (PaaS) 708, and/or software as a service (Saas) 706 using a web browser, mobile app, thin client, terminal emulator or other endpoint 704, as depicted in FIG. 7.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, a request for classification of an audio file, the audio file comprising audio content;
analyzing, by the device, the audio file, and determining a signal data signature (SDS) for the audio file;
generating, by the device, based on a set of neural network models, a model performance confusion matrix, model performance confusion matrix corresponding to a set of models that correspond to a threshold based SDS analysis threshold;
performing, by the device, a performance evaluation based on the model performance confusion matrix, the performance evaluation comprising determining neural network models that produce a quantity of false outputs at or below a threshold level;
performing, by the device, a model performance grouping, the model performance grouping comprising organizing a set of configuration models based on a type of output from each configuration model, the type of output corresponding to a positive, negative and nofalse predictions;
generating, by the device, based on the model performance grouping, a set of stacks, the set of stacks corresponding to the positive, negative and nofalse predictions;
assembling, by the device, an oracle data structure based on the generated set of stacks, the assembly of the oracle data structure comprising storage in a database; and
determining and outputting, by the device, an SDS classification for the audio file.

2. The method of claim 1, further comprising:
analyzing, by the device, each configuration in the generated set of stacks; and
determining, by the device, a model configuration for each model in the stack, wherein the assembled oracle data structure is based on the determined model configuration for each model.

3. The method of claim 1, further comprising:
analyzing, by the device, each configuration in the generated set of stacks; and
determining, by the device, an order of operation based on the model configuration for each model in the stack, wherein the assembled oracle data structure is based on certain models being queried in a specific order.

4. The method of claim 1, wherein the model performance confusion matrix comprises the set of models that include at least one of an average model, maximum model, vote model and vote average model.

5. The method of claim 1, further comprising:
correlating a set of results for each of the set of models associated with the model performance confusion matrix; and
storing information related to the correlation in the database.

6. The method of claim 5, wherein the set of results comprises a score based at least in part on the positive predictions.

7. The method of claim 6, further comprising:
determining, by the device, an average of predictions by each configuration model in the set of configuration models; and
generating, by the device, the score of each configuration model based at least in part on the average of the predictions exceeding a positive threshold value.

8. The method of claim 1, wherein the false output corresponds to at least one of a false negative and false positive.

9. The method of claim 1, further comprising:
executing, by the device, a prediction on a model pairing based on the SDS; and
aggregating, by the device, the predictions, wherein the SDS classification is based on the aggregation.

10. A non-transitory computer-readable storage medium tangibly encoded without computer-executable instructions, that when executed by a device, perform a method comprising:
receiving, by the device, a request for classification of an audio file, the audio file comprising audio content;
analyzing, by the device, the audio file, and determining a signal data signature (SDS) for the audio file;
generating, by the device, based on a set of neural network models, a model performance confusion matrix, model performance confusion matrix corresponding to a set of models that correspond to a threshold based SDS analysis threshold;
performing, by the device, a performance evaluation based on the model performance confusion matrix, the performance evaluation comprising determining neural network models that produce a quantity of false outputs at or below a threshold level;
performing, by the device, a model performance grouping, the model performance grouping comprising organizing a set of configuration models based on a type of output from each configuration model, the type of output corresponding to a positive, negative and nofalse predictions;
generating, by the device, based on the model performance grouping, a set of stacks, the set of stacks corresponding to the positive, negative and nofalse predictions;
assembling, by the device, an oracle data structure based on the generated set of stacks, the assembly of the oracle data structure comprising storage in a database; and
determining and outputting, by the device, an SDS classification for the audio file.

11. The non-transitory computer-readable storage medium of claim 10, further comprising:
analyzing, by the device, each configuration in the generated set of stacks; and
determining, by the device, a model configuration for each model in the stack, wherein the assembled oracle data structure is based on the determined model configuration for each model.

12. The non-transitory computer-readable storage medium of claim 10, further comprising:
analyzing, by the device, each configuration in the generated set of stacks; and
determining, by the device, an order of operation based on the model configuration for each model in the stack, wherein the assembled oracle data structure is based on certain models being queried in a specific order.

13. The non-transitory computer-readable storage medium of claim 10, further comprising:
executing, by the device, a prediction on a model pairing based on the SDS; and
aggregating, by the device, the predictions, wherein the SDS classification is based on the aggregation.

14. The non-transitory computer-readable storage medium of claim 10, further comprising determining, by the device, a score based at least in part on the positive predictions.

15. The non-transitory computer-readable storage medium of claim 14, further comprising:
determining, by the device, an average of predictions by each configuration model in the set of configuration models; and
generating, by the device, the score of each configuration model based at least in part on the average of the predictions exceeding a positive threshold value.

16. A device comprising:
a processor configured to:
receive a request for classification of an audio file, the audio file comprising audio content;
analyze the audio file, and determine a signal data signature (SDS) for the audio file;
generate, based on a set of neural network models, a model performance confusion matrix, model performance confusion matrix corresponding to a set of models that correspond to a threshold based SDS analysis threshold;
perform a performance evaluation based on the model performance confusion matrix, the performance evaluation comprising determining neural network models that produce a quantity of false outputs at or below a threshold level;
perform a model performance grouping, the model performance grouping comprising organizing a set of configuration models based on a type of output from each configuration model, the type of output corresponding to a positive, negative and nofalse predictions;
generate, based on the model performance grouping, a set of stacks, the set of stacks corresponding to the positive, negative and nofalse predictions;
assemble an oracle data structure based on the generated set of stacks, the assembly of the oracle data structure comprising storage in a database; and
determine and output an SDS classification for the audio file.

17. The device of claim 16, wherein the processor is further configured to:
analyze each configuration in the generated set of stacks; and
determine a model configuration for each model in the stack, wherein the assembled oracle data structure is based on the determined model configuration for each model.

18. The device of claim 16, wherein the processor is further configured to:
analyze each configuration in the generated set of stacks; and
determine an order of operation based on the model configuration for each model in the stack, wherein the assembled oracle data structure is based on certain models being queried in a specific order.

19. The device of claim 16, wherein the processor is further configured to:
execute a prediction on a model pairing based on the SDS; and
aggregate the predictions, wherein the SDS classification is based on the aggregation.

20. The device of claim 16, further comprising:
determining, by the device, an average of predictions by each configuration model in the set of configuration models; and
generating, by the device, a score of each configuration model based at least in part on the average of the predictions exceeding a positive threshold value.
